(19) United States
(12) Patent Application Publication
(10) Pub. No.: US 2009/0292988 A1
(43) Pub. Date: Nov. 26, 2009

(54) SYSTEM AND METHOD FOR ADJUSTING FONT SIZE OF INFORMATION DISPLAYED IN AN ELECTRONIC DEVICE

(75) Inventor: YUH-HUNG WENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/468,064

(22) Filed: May 19, 2009

(30) Foreign Application Priority Data
May 20, 2008 (CN) 200810301670.1

(51) Int. Cl. G06F 17/00

(52) U.S. Cl. 715/269

(57) ABSTRACT

An electronic device includes a display unit, a distance detector, a control unit, and a converting unit. The display unit is used for displaying information. The distance detector operatively detects a distance between an object and the display unit. The memory stores a table relating font size to predetermined distance, the table includes a plurality of distances and a plurality of font sizes, each distance is associated with a font size correspondingly. The control unit is used for searching the table to obtain a matching font size according to the detected distance. The display unit displays the information in the matching font size. A related method is also provided.

### BACKGROUND

1. Technical Field

The disclosed embodiments relate to a system and method for automatically adjusting font size of characters displayed in an electronic device.

2. Description of Related Art

Electronic devices, such as personal digital assistants (PDA), mobile phones, televisions, and personal computers, are increasingly becoming electronic readers (e-readers) for electronic books (e-books).

However, the font size of the characters displayed on the screen may not be suitable for all readers/users because the eyesight of each reader/user may be different. Furthermore, if the distance between the user and the display screen increases, the user may not clearly see the characters displayed in the display screen.

What is needed, therefore, is a system and method for adjusting a font size of information displayed in the electronic device to overcome the described limitation.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an electronic device in accordance with an exemplary embodiment.

FIG. 2 is a block diagram of one embodiment of a system for adjusting font size of characters displayed in the electronic device of FIG. 1.

FIG. 3 is a flowchart of one embodiment of a method for adjusting font size of information displayed in the electronic device of FIG. 1.

### DETAILED DESCRIPTION

All of the processes described hereinafter, may be embodied in, and fully automated via, functional code modules executed by one or more general purpose computers or processors. The code modules may be stored in any type of computer-readable medium or other storage device. Some or all of the methods may alternatively be embodied in specialized hardware or electronic apparatus.

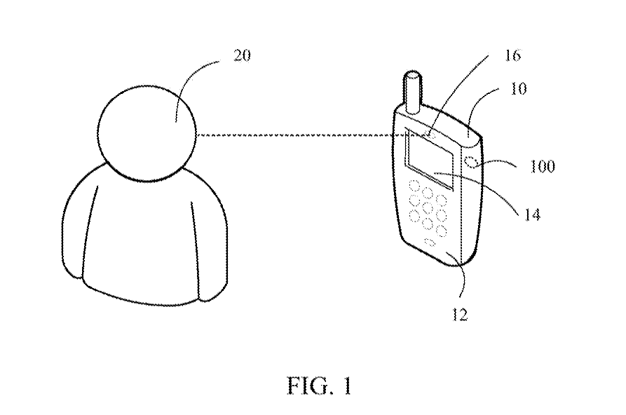

FIG. 1 is a schematic view of an electronic device 10 in accordance with an exemplary embodiment. The electronic device 10 includes a display unit 14, a distance detector 16, and a system 100. The display unit 14 and the distance detector 16 are disposed on a front side 12 of the electronic device 10. The system 100 is disposed in the electronic device 10.

The distance detector 16 is used for detecting a distance between the electronic device 10 and an adjacent object 20, such as a viewer, directly in front of the display unit 14. In this embodiment, the distance detector 16 is an infrared sensor, which emits infrared light to the object 20 at a first time point and receives the infrared light reflected from the object 20 at a second time point, acquires a time interval between the first time point and the second time point, and calculates the distance between the object 20 and the display unit 14 according to the time interval. In other embodiment, the distance detector 16 may be an ultrasonic detector capable of emitting ultrasonic waves.

The system 100 is used for adjusting a font size of characters displayed in the display unit 14 according to the detected distance. If the detected distance is larger than a predetermined reference distance stored in the electronic device 10, then the font size can be increased. Therefore, the characters displayed by the electronic device 10 can be read more clearly by viewers having poor eyesight. If the detected distance is smaller than the predetermined reference distance, then the font size can be decreased, so as to adapt to different user preferences.

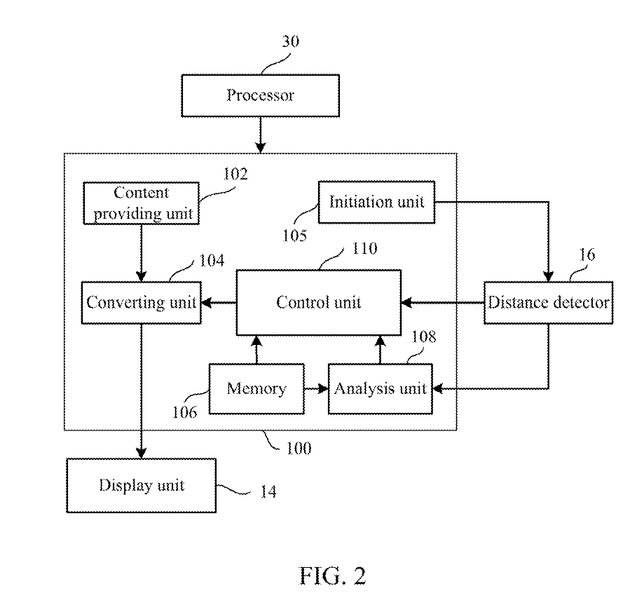

FIG. 2 is a block diagram of one embodiment of the system 100 for adjusting the font size of characters displayed in the electronic device 10. The system 100 includes a content providing unit 102, a converting unit 104, an initiation unit 105, a memory 106, an analysis unit 108, and a control unit 110. Additionally, the electronic devices 10 may comprise one or more specialized or general purpose processors, such as the processor 30 for executing the content providing unit 102, the converting unit 104, the initiation unit 105, the memory 106, the analysis unit 108, and the control unit 110.

The content providing unit 102 is used for providing information, such as an e-book. The information may include text and image. The converting unit 104 is used for converting the information to signals, and providing the signals to the display unit 14 for display.

The initiation unit 105 is used for activating the distance detector 16 to detect a distance between the object 20 and the electronic device 10. The memory 106 stores a table that relates font size to predetermined distance. The table includes a plurality of distances and a plurality of font sizes. Each distance of the plurality of distances is associated with a font size of the plurality of font sizes correspondingly.

The analysis unit 108 is used for measuring an actual time interval that an object is in front of the electronic device 10, and comparing the actual time interval with a predetermined time interval stored in the memory 106. If the actual time interval is equal to or less than the predetermined time interval, nothing is performed because this may be a temporary object between the user/reader and the electronic device 10 and the font size remains the same. If the actual time is longer than the predetermined time interval, then the analysis unit 108 generates an enabling signal to the control unit 110. The control unit 110 is activated when receiving the enabling signal and searches the table for a matching font size according to the detected distance.

The converting unit 104 is also used for adjusting the font size of characters of the text information to the matching font size, so as to generate adjusted signals. The display unit 14 displays information according to the adjusted signals, thus the characters are displayed in the matching font size. In this embodiment, the plurality of distances and corresponding font sizes in the table can be adjusted manually, so as to adapt to different user preference, therefore the user with different eyesight can clearly see the characters displayed in the display unit 14.

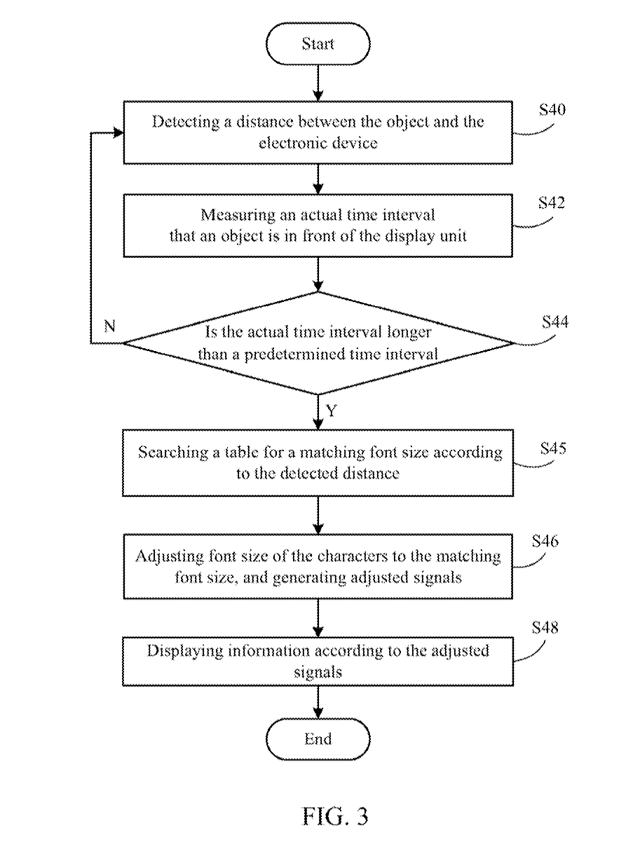

FIG. 3 is a flowchart of one embodiment of a method for adjusting font size of characters displayed in an electronic device. Additional blocks may be added and blocks may be executed in a different order than that described without deviating from the spirit of the disclosure.

In block S40, the initiation unit 105 activates the distance detector 16 to detect a distance between the object 20 and the display unit 14.

In block S42, the analysis unit 108 measures the actual time interval that an object is in front of the display unit 14.

In block S44, the analysis unit 108 compares the actual time interval with a predetermined time interval, and determines whether the actual time interval is longer than the predetermined time interval. In this embodiment, if the actual time interval is equal to or less than the predetermined time interval, the operation returns to the block S40 and the font size remains the same.

In block S45, if the actual time interval is longer than the predetermined time interval, the analysis unit 108 activates the control unit 110 to search a table that relates font size to predetermined distance stored in the memory 106 for a matching font size according to the detected distance. In this embodiment, the table includes a plurality of distances and a plurality of font sizes. Each distance of the plurality of distances is associated with a font size of the plurality of font sizes correspondingly. The plurality of distances and the plurality of font sizes are adjusted.

In block S46, the converting unit 104 adjusts a font size of characters of the text information in the information to the matching font size, and generates adjusted signals.

In block S48, the display unit 14 displays information according to the adjusted signals, thus the characters are displayed in the matching font size.

Alternative embodiments will become apparent to those skilled in the art to which the present invention pertains without departing from the spirit and scope. Accordingly, the present invention should be deemed not to be limited to the above detailed description, but rather by the claims that follow.

What is claimed is:

1. An electronic device, comprising:
a display unit for displaying information;
a distance detector operatively activated to detect a distance between an object and the display unit;
a memory for storing a table that relates font size to predetermined distance, the table comprising a plurality of distances and a plurality of font sizes, each distance being associated with a font size correspondingly; and
a control unit for performing a searching operation for searching the table for a matching font size according to the detected distance;
wherein the display unit displays the information in the matching font size.

2. The electronic device of claim 1, further comprising a converting unit for adjusting font size of characters in the information to the matching font size.

3. The electronic device of claim 2, wherein if the detected distance is larger than a predetermined reference distance, then the font size is increased, and if the detected distance is smaller than the predetermined reference distance, then the font size is decreased.

4. The electronic device of claim 2, further comprising a content providing unit for providing the information, wherein the information is converted by the converting unit to signals for display.

5. The electronic device of claim 1, wherein the plurality of distances and the plurality of font sizes can be adjusted.

6. The electronic device of claim 1, further comprising an analysis unit for measuring an actual time interval that an object is in front of the display unit, and comparing the actual time interval with a predetermined time interval stored in the memory, wherein if the actual time interval is longer than the predetermined time interval, then the analysis unit activates the searching operation of the control unit.

7. The electronic device of claim 6, wherein if the actual time interval is equal to or less than the predetermined time interval, the font size remains the same.

8. The electronic device of claim 1, wherein the distance detector is an infrared sensor emitting infrared light to the object at a first time point and receiving reflected infrared light from the object at a second time point, acquires a time interval between the first time point and the second time point, and calculates the distance between the object and the display unit according to the time interval.

9. The electronic device of claim 1, further comprising an initiation unit for activating the distance detector.

10. A method for adjusting font size of characters displayed in an electronic device, the method comprising:
detecting a distance between an object and a display unit;
searching a table that relates font size to predetermined distance, the table comprising a plurality of distances and a plurality of font sizes, each distance being associated with a font size correspondingly, to obtain a matching font size according to the detected distance; and
displaying information in the matching font size.

11. The method of claim 10, further comprising:
adjusting the font size of characters displayed in the display unit to the matching font size.

12. The method of claim 10, further comprising:
measuring an actual time interval that an object is in front of the display unit;
comparing the actual time interval with a predetermined time interval; and
searching the table for the matching font size according to the detected distance if the actual time interval is longer than the predetermined time interval.

13. The method of claim 12, wherein if the actual time interval is equal to or less than the predetermined time interval, the font size remains the same.

14. The method of claim 10, wherein the plurality of distances and the plurality of font sizes can be adjusted.

15. A computer-readable medium providing instructions, which if executed by a processor, causes the processor to perform operations comprising:
detecting a distance between an object and a display unit;
searching a table that relates font size to predetermined distance, the table comprising a plurality of distances and a plurality of font sizes, each distance being associated with a font size correspondingly, to obtain a matching font size according to the detected distance; and
displaying information in the matching font size.

16. The computer-readable medium of claim 15, further providing instructions, which if executed by the processor, causes the processor to perform the operations comprising:
adjusting the font size of characters displayed in the display unit to the matching font size.

17. The computer-readable medium of claim 15, further providing instructions, which if executed by the processor, causes the processor to perform the operations comprising:
measuring an actual time interval that an object is in front of the display unit;
comparing the actual time interval with a predetermined time interval; and
searching the table to obtain the matching font size according to the detected distance if the actual time interval is longer than the predetermined time interval.

18. The computer-readable medium of claim 17, wherein if the actual time interval is equal to or less than the predetermined time interval, the font size remains the same.

19. The computer-readable medium of claim 15, wherein the plurality of distances and the plurality of font sizes can be adjusted.
